(19) United States
(12) Patent Application Publication
(10) Pub. No.: US 2009/0237177 A1
(43) Pub. Date: Sep. 24, 2009

(54) Miniaturized microwave sampler

(75) Inventors: Tzyh-Ghuang Ma, Jhonghe City (TW); Chin-Feng Chou, Hsinchu (TW)

Correspondence Address: COOPER & DUNHAM, LLP, 30 Rockefeller Plaza, 20th Floor, NEW YORK, NY, 10112, US

(73) Assignee: FINETEK CO., LTD.

(21) Appl. No.: 12/077,391

(22) Filed: Mar. 19, 2008

(51) Int. Cl. H01P 5/20

(52) U.S. Cl. 333/121

(57) ABSTRACT

A miniaturized microwave sampler has a first substrate and a second substrate mounted together on a mounting surface, a ground layer formed on the mounting surface, a slot-line formed on the ground layer. A first microstrip line is formed on a top surface of the first substrate and has a first end as a local pulse signal input port. A T-shaped second microstrip line is formed on a bottom surface of the second substrate and achieves an electromagnetic coupling with the first microstrip line through the slot-line. The second microstrip line has a longitudinal segment and a latitudinal segment both being perpendicularly connected together. The longitudinal segment has one end as a radio frequency signal input port. The latitudinal segment further extends to form two output ports.

### BACKGROUND OF THE INVENTION

1. Field of the Invention

The present invention relates to a miniaturized microwave sampler, and more particularly to a miniaturized microwave sampler that uses for ultra-wideband (UWB) communication technology and time-domain reflectometry (TDR) measurement technique.

2. Description of the Prior Arts

A microwave sampler is an essential component in the RF front-end of a receiver in many applications such as the ultra-wideband (UWB) communication system and the time-domain reflectometry (TDR) system. However, the size of the conventional microwave sampler is large and should be improved.

With reference to FIG. 7, a sampling module in the receiver of the UWB communication system comprises a microwave sampler (70) and a digital signal processing circuit (80). The digital signal processing circuit (80) includes an analog/digital (A/D) converter (81), a filter (82) and a baseband processor (83). The microwave sampler (70) has two different major types, the balance structure or the ring structure.

With reference to FIG. 8, a microwave sampler (70) of the balance structure comprises a sampling bridge circuit (71) and a summing circuit (72).

The sampling bridge circuit (71) is consisted of two wave-mixing diodes (D1, D2) and two sampling capacitors (C1, C2). The two wave-mixing diodes (D1, D2) are connected in series at a node, where the node is used as a radio frequency (RF) signal input port to receive a RF signal. Each of the two sampling capacitors (C1,C2) is connected to a corresponding wave-mixing diode (D1, D2).

The summing circuit (72) has two input terminals and an output terminal. The two input terminals respectively connect to two nodes where the wave-mixing diodes (D1, D2) and the two sampling capacitors (C1, C2) are connected. The output terminal of the summing circuit (72) is used as an intermediate frequency (IF) output port and connected to a load resistor (RL).

The two sampling capacitors (C1, C2) may be directly connected to the summing circuit (72).

The local signal (LO) is a series of pulse signals generated by a pulse generator. When the local signal is converted by a balun, which converts between balanced and unbalanced signals, a phase-reversed local signal (LO) accordingly generates. When the local signal is input to the wave-mixing diodes (D1, D2), the wave-mixing diodes (D1, D2) are turned on so that the local signal multiplies the RF signal together and the sampling capacitors (C1, C2) are charged. After the local signal passes through the wave-mixing diodes (D1, D2), the wave-mixing diodes (D1, D2) are turned off. The sampling capacitors (C1, C2) then discharge to the load resistor (RL) through the summing circuit (72) to obtain sampling data of the RF signal over the load resistor (RL).

With further reference to FIG. 9, the microwave sampler (70) comprises a rectangular substrate (701), a ground layer (702), a coplanar waveguide (703) and a first microstrip line (705). The rectangular substrate (701) has a top surface, a bottom surface, a long edge and a short edge. The ground layer (702) is formed on the top surface of the substrate (701). The coplanar waveguide (703) is formed on ground layer (702) and parallel to the long edge. The coplanar waveguide (703) is formed on the ground layer (702) and is consisted of a metallic strip (704) and two slot-lines (707). The coplanar waveguide (703) has one end as the RF signal input port and the other end connected to the sampling bridge circuit (71). The first microstrip line (705) is parallel to the short edge and formed on the bottom surface of the substrate (701). The first microstrip line (705) has one end as the local signal (LO) input port and the other end connected with a resistor that electrically connects to the ground layer (702) through a via.

The first microstrip line (705) is perpendicular to the coplanar waveguide (703) to form a so-called “magic T” circuit. The length from the RF signal input port to an intersection of the first microstrip line (705) and the coplanar waveguide (703) is λ/4. The length from the intersection to the sampling bridge circuit (71) is also λ/4.

Two connecting wires (706) are further formed on the bottom surface of the substrate (701). The connecting wires (706) with their first ends respectively connected to the sampling bridge circuit (71) through vias, and the other ends of the connecting wires (706) are connected together to form an intermediate frequency (IF) output port.

The entire size of the microwave sampler (70) is mainly depended on the magic T circuit. Since the magic T circuit occupies a large area on the substrate (701) and the sampling bridge (71) as well as other related signal lines are all formed on the substrate (701), reducing the size of the microwave sampler (70) effectively is very difficult.

### SUMMARY OF THE INVENTION

The main objective of the present invention is to provide a miniaturized microwave sampler with a reduced size by miniaturizing the magic T circuit fabricated in the microwave sampler.

To accomplish the objective, the microwave sampler has a substrate assembly, a ground layer and a magic T circuit.

The substrate assembly comprises a first substrate and a second substrate mounted together on a mounting surface, both the first substrate and the second substrate having a top surface and a bottom surface.

The ground layer is formed on the mounting surface.

The magic T circuit is formed in the substrate assembly and has a slot-line, a first microstrip line and a second T-shaped microstrip line.

The slot-line is formed on the ground layer.

The first microstrip line is formed on the top surface of the first substrate and has a first end as local pulse signal input port, and a second end extending along a direction to perpendicularly cross to the slot-line.

The second microstrip line is formed on the bottom surface of the second substrate, achieves an electromagnetic coupling with the first microstrip line through the slot-line, and has a longitudinal segment and a latitudinal segment both being connected together to form the T shape. The longitudinal segment extends along a direction being parallel to the slot-line, connects to the latitudinal segment, and has a first end as a radio frequency (RF) signal input port and a second end perpendicularly connected to the latitudinal segment.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a miniaturized microwave sampler in accordance with the present invention;

FIG. 2 is a cross sectional view of the miniaturized microwave sampler in accordance with the present invention;

FIG. 3 is a schematic view of the electric field of the miniaturized microwave sampler in accordance with the present invention;

FIGS. 4A-4F are characteristic charts of the miniaturized microwave sampler in accordance with the present invention;

FIG. 5 is a circuit diagram of the miniaturized microwave sampler in accordance with the present invention;

FIGS. 6A-6D are simulation charts of signal processing properties of the miniaturized microwave sampler in accordance with the present invention;

FIG. 7 is a bottom perspective view of the miniaturized microwave sampler in accordance with the present invention;

FIG. 8 is a circuit block diagram of a sampling module in a signal input stage of an UWB communication system;

FIG. 9 is a circuit diagram of a conventional microwave sampler; and

FIG. 10 is a top plan view of the conventional microwave sampler.

### DETAILED DESCRIPTION OF THE PREFERRED EMBODIMENTS

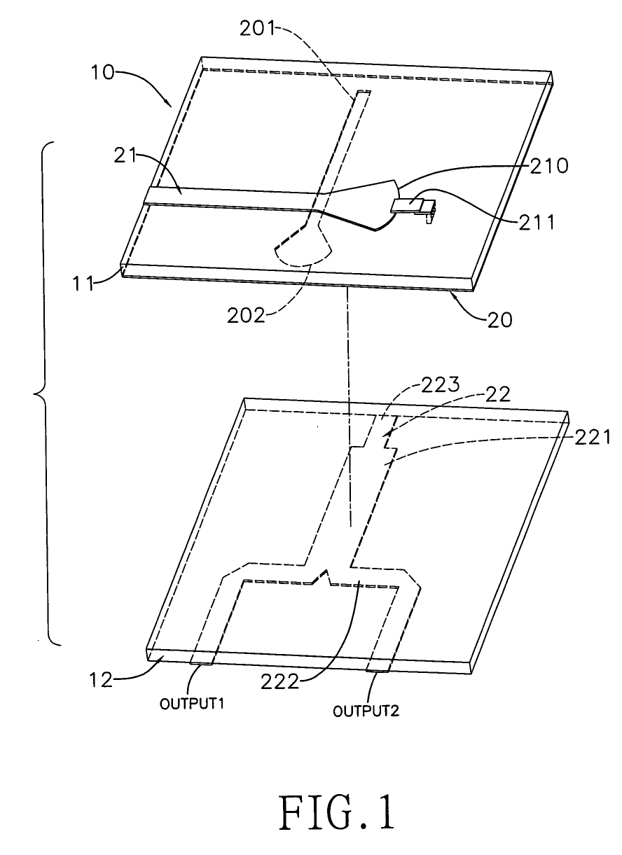

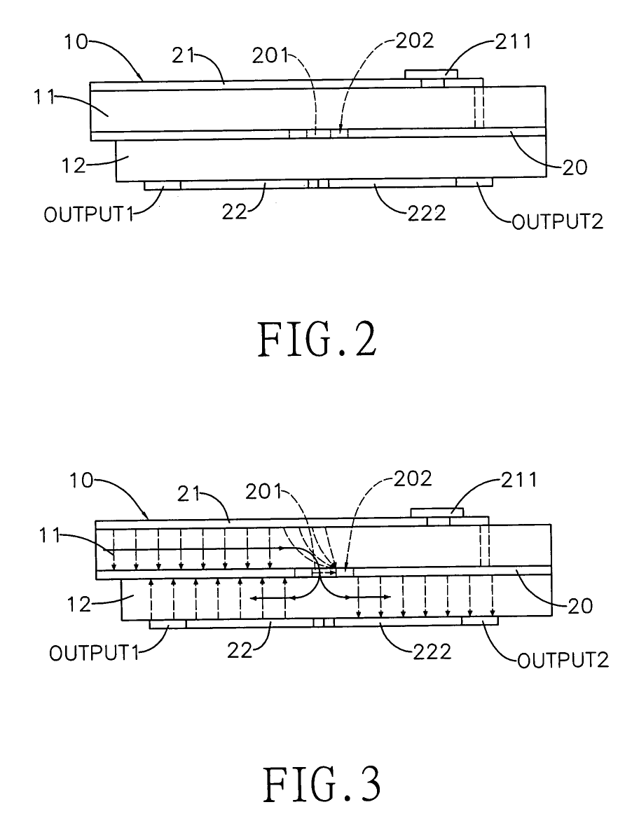

With reference to FIGS. 1 and 2, a miniaturized microwave sampler comprises a substrate assembly (10) integrated with a magic T circuit. The substrate assembly (10) includes a first substrate (11) and a second substrate (12) mounted together on a mounting surface. Preferably, the first substrate (11) and the second substrate (12) are rectangular substrates, each having two long edges and two short edges. A ground layer (20) is formed on the mounting surface where the first substrate (11) and the second substrate (12) are attached to each other. In this embodiment, the mounting surface is a bottom surface of the first substrate (11). Alternatively, the mounting surface can be a top surface of the second substrate (12).

The magic T circuit comprises a slot-line (201), a first microstrip line (21) and a second microstrip line (22).

The slot-line (201) with two ends is formed on the ground layer (20), positioned approximated at the center of the first substrate (11), and is longitudinally parallel to the short edges of the first substrate (11). The first end of the slot-line (201) is enlarged to form a radial stub (202) having a length approximating to λ/4. The shape of the stub (202) can be modified to a circular, elliptic, triangular or a crooked shape to achieve impedance matching. The second end of the slot-line (201) is short-circuited to the ground plane (20).

The first microstrip line (21) with two ends is formed on the top surface of the first substrate (11) and has a long and narrow shape being parallel to the longer side of the first substrate (11). The first end of the first microstrip line (21) is served as a local pulse signal (LO) input port by connecting a microwave connector between the first microstrip line (21) and the ground plane (20). The second end of the first microstrip line (21) extends along a direction to perpendicularly cross to the slot-line (201) and is enlarged to form an open-circuited radial stub (210). The radial stub (210) has a length approximating to λ/4 and connects to a 100-ohms resistor (211). The resistor (211) as a load for the local pulse signal is electrically connected to the ground layer (20) through a via. Since the lengths of the microstrip open-circuited radial stub (210) and the slot-line short-circuited radial stub (202) are all approximately λ/4, the microwave sampler of the present invention has the wideband property for signal transition.

The second microstrip line (22) is formed on the bottom surface of the second substrate (12) and comprises a longitudinal segment (221) and a latitudinal segment (222) both being connected together to form a T shape. The longitudinal segment (221) extends along a direction being parallel to the slot-line (201) on the ground layer (20). An electromagnetic coupling is achieved between longitudinal segment (221) and the first microstrip line (21) through the slot-line (201). The longitudinal segment (221) has a first end being connected to the latitudinal segment (222), and a second end being an impedance converter (223) with a length of λ/4. The impedance converter (223) is excited at the edge of the second substrate (12) with a microwave connector and served as a radio frequency (RF) signal input port. The latitudinal segment (222) has two ends from which two wires respectively extend to the other edge of the second substrate (12) opposite to the impedance converter (223) as two output ports (OUTPUT 1, OUTPUT 2).

The function of the microwave sampler is basically accomplished by the electromagnetic coupling generated by the magic T circuit using three layers, i.e. the slot-line (201), the first microstrip line (21) and the second microstrip line (22).

The first microstrip line (11) formed on the first substrate (11) transmits the local pulse signal and the resistor is used as a load for the local pulse signal. The combination of the first layer and the second layer has a function of microstrip to slot-line transition. Since the first microstrip line (21) has the open-circuited radial stub (210) with a length λ/4, and the slot-line (202) also has the short-circuited radial stub (202) with a length λ/4, the transition has the wideband effect.

With reference to FIG. 3, the signal propagating along the second microstrip line (22) has two modes respectively for signals received at the RF input port and the local pulse signal input port. In the first mode, the amplitudes and phases of the output signals at the two output ports (OUTPUT 1, OUTPUT 2) are the same if the signal is injected from the RF input port. It is also referred to as the even mode. In the second mode, the phases of output signals at the two output ports (OUTPUT 1, OUTPUT 2) are opposite to each other by 180 degrees as the signal is injected from the local pulse signal input port of the first microstrip line (21). It is also referred to as the odd mode. In the second mode, the signals both have the same amplitudes. Because the local pulse signal input port and the RF signal input port are separated by the ground layer (20), a balance-structure based sampling bridge can be achieved between the two output ports (OUTPUT 1, OUTPUT 2).

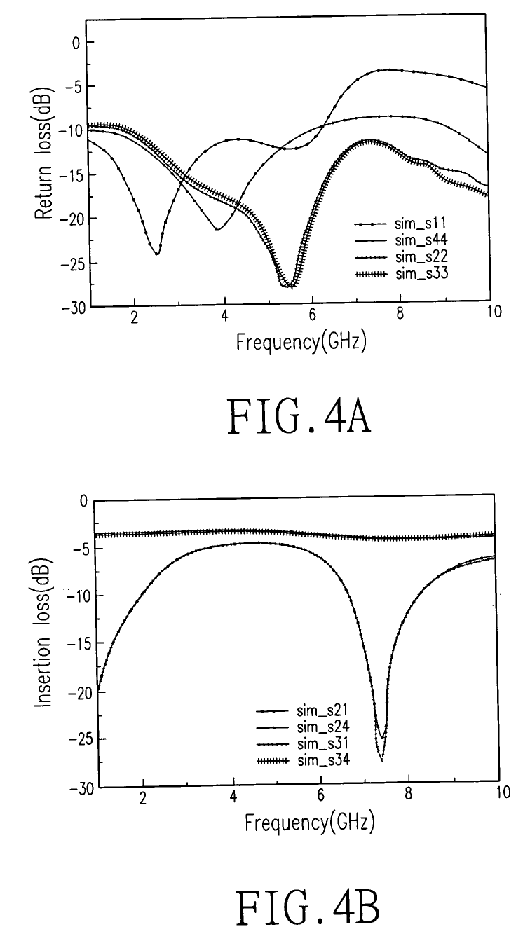

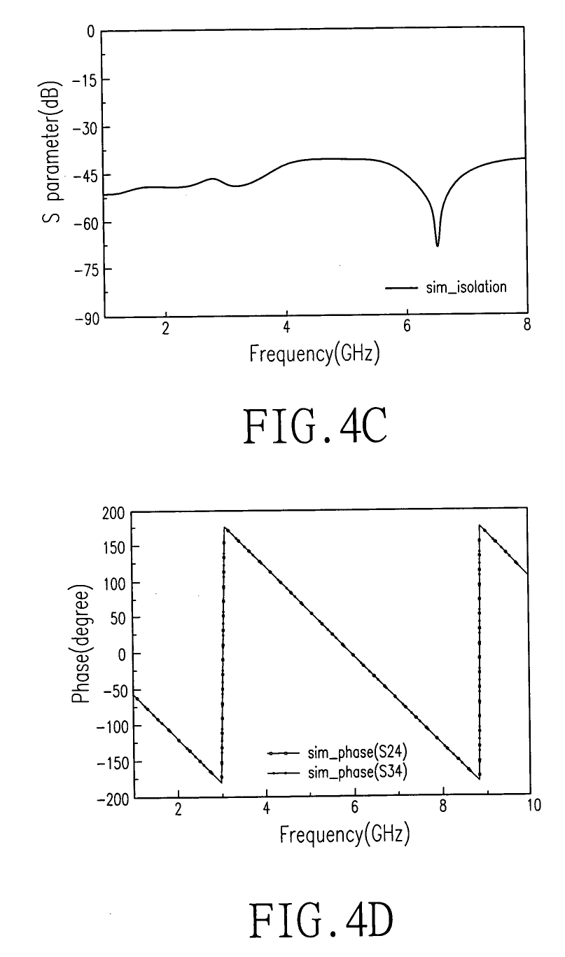

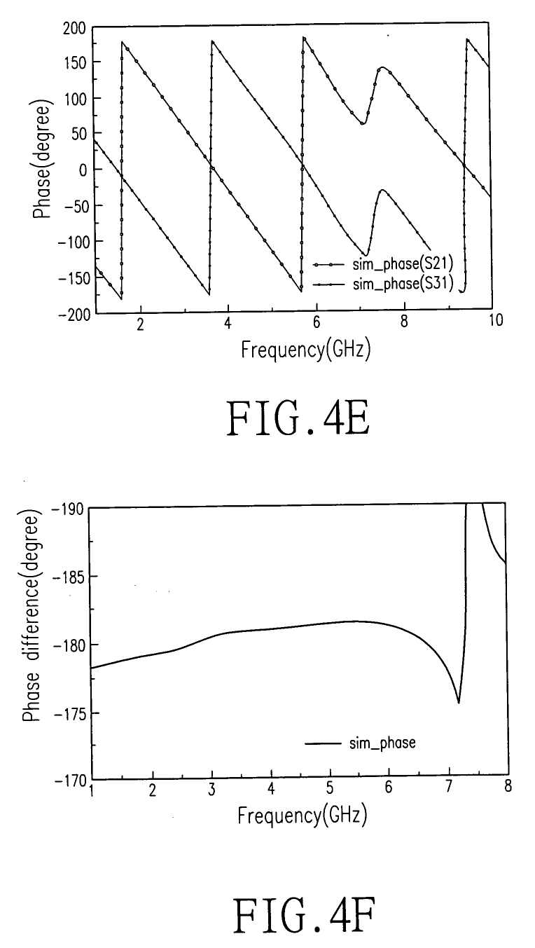

With reference to FIG. 4A, the return loss characteristics of the local pulse signal input port, the RF signal input port, the two output ports (OUTPUT 1, OUTPUT 2) measured from 0 to 6 G Hz are respectively represented by different curves.

With reference to FIG. 4B, the insertion loss characteristics between the local pulse signal input port, the RF signal input port, and the two output ports (OUTPUT 1, OUTPUT 2) measured from 0 to 6 G Hz are respectively represented by curves. The insertion losses measured between the local pulse signal input port and the two output ports (OUTPUT 1, OUTPUT 2) are approximately 5 dB from 3 to 6 G Hz. The insertion losses measured between the RF signal input port and the two output ports (OUTPUT 1, OUTPUT 2) are approximately 4 dB from 0 to 6 G Hz.

With reference to FIG. 4C, the isolation characteristic is lower than 35 dB which prevents the RF signal input port from interfering with the local pulse signal input port.

With reference to FIG. 4D, the phases of the signals measured between the RF input port and the output ports (OUTPUT 1, OUTPUT 2) are the same.

With reference to FIG. 4E, the phases of the signals measured at the local pulse signal input port and the output ports (OUTPUT 1, OUTPUT 2) are opposite to each other by 180 degrees.

With reference to FIG. 4F, the phase difference between the signals measured at the local pulse signal input port and the two output ports (OUTPUT 1, OUTPUT 2) are opposite to each other by 180 degrees.

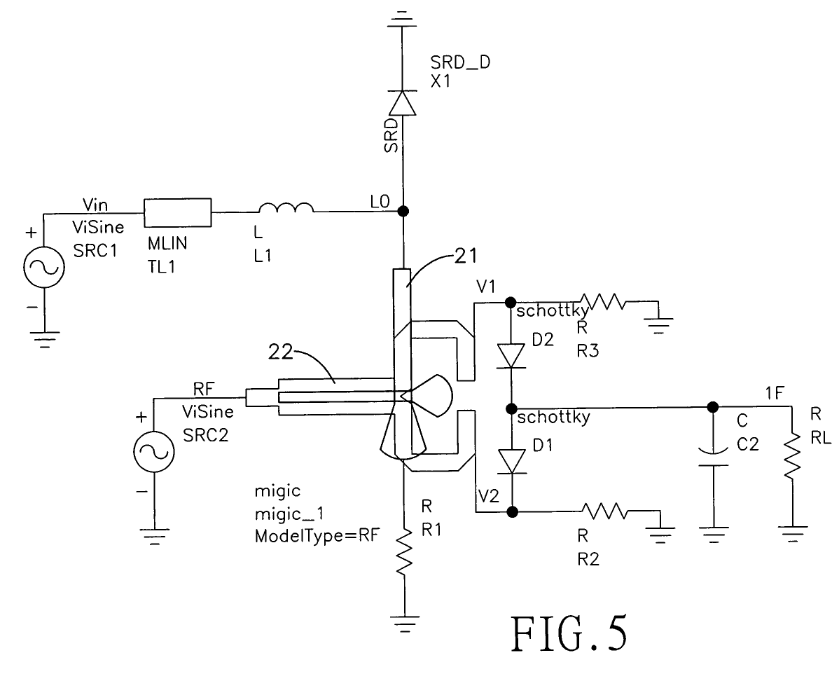

With reference to FIG. 5, the magic T circuit is integrated with a sampling bridge circuit. Some simulation results based on the integrated circuit are described as following.

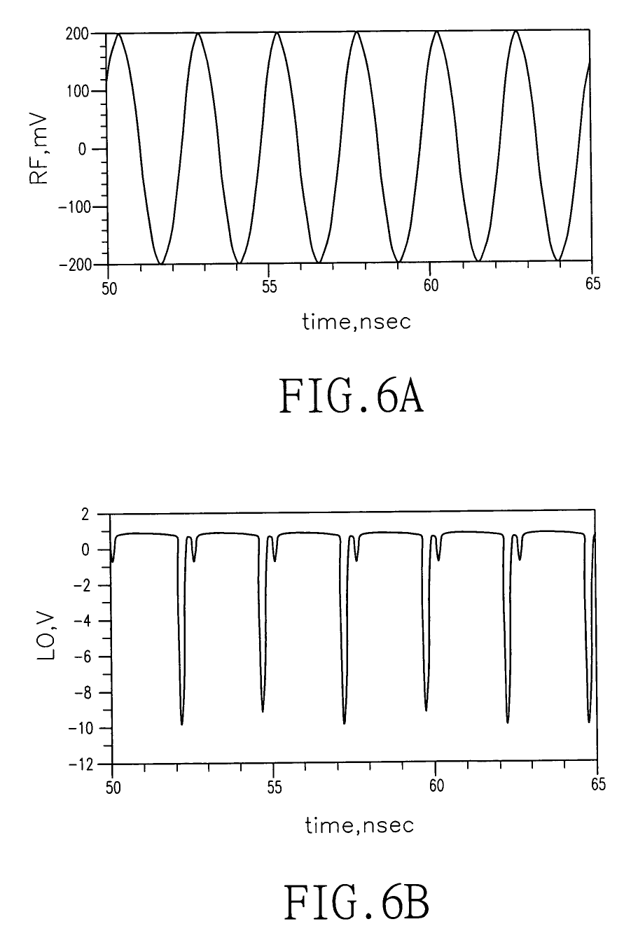

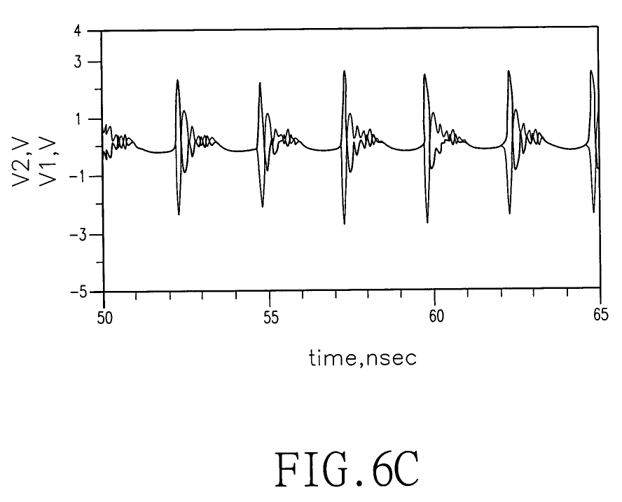

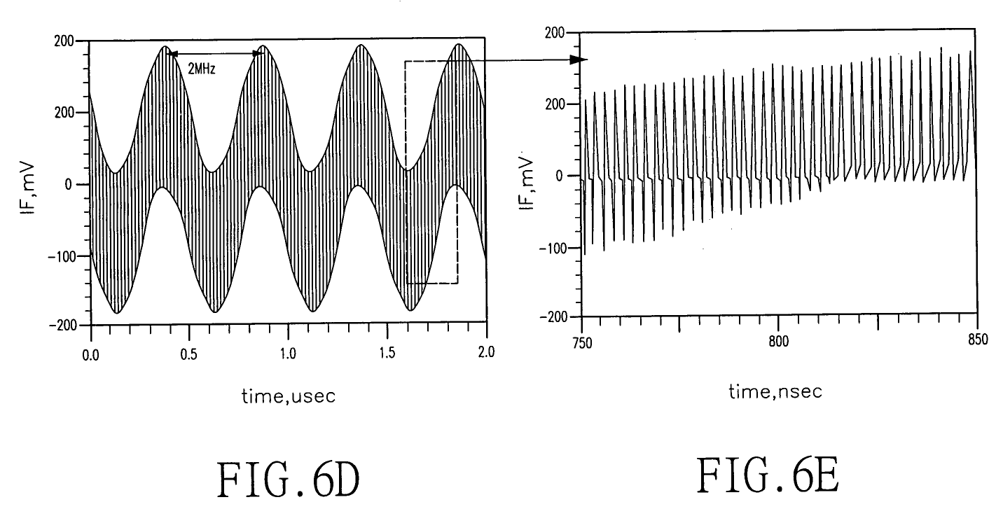

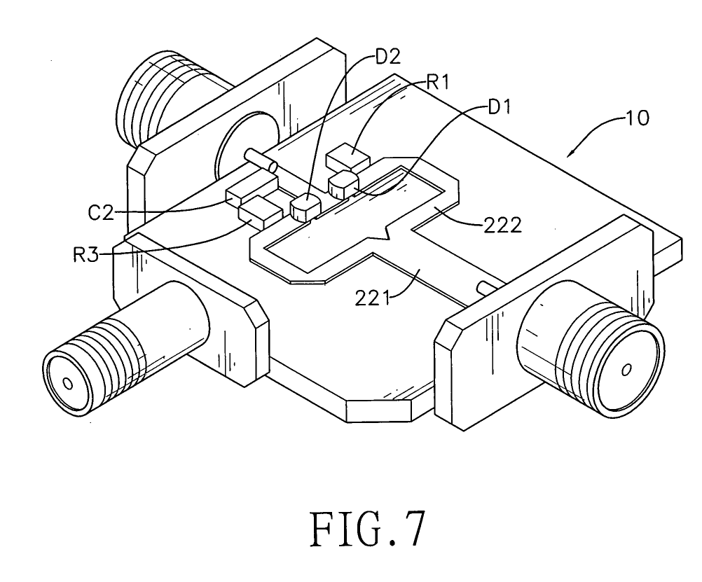

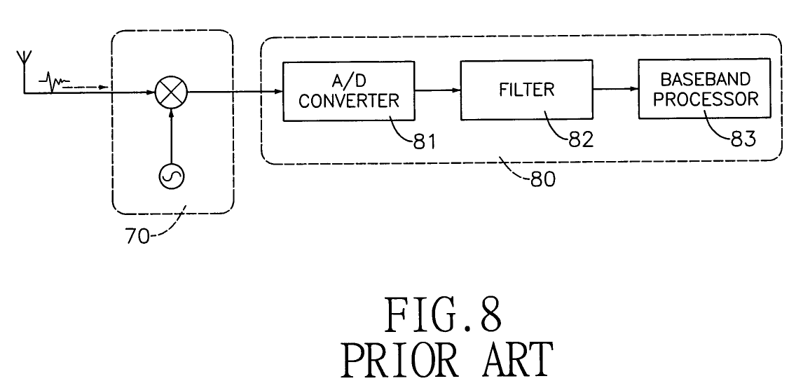

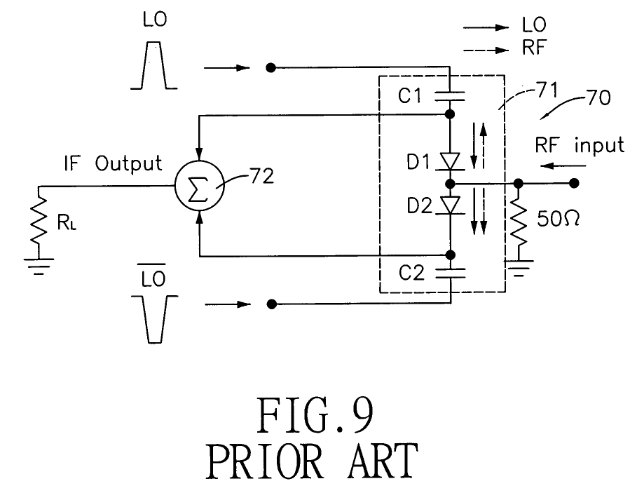

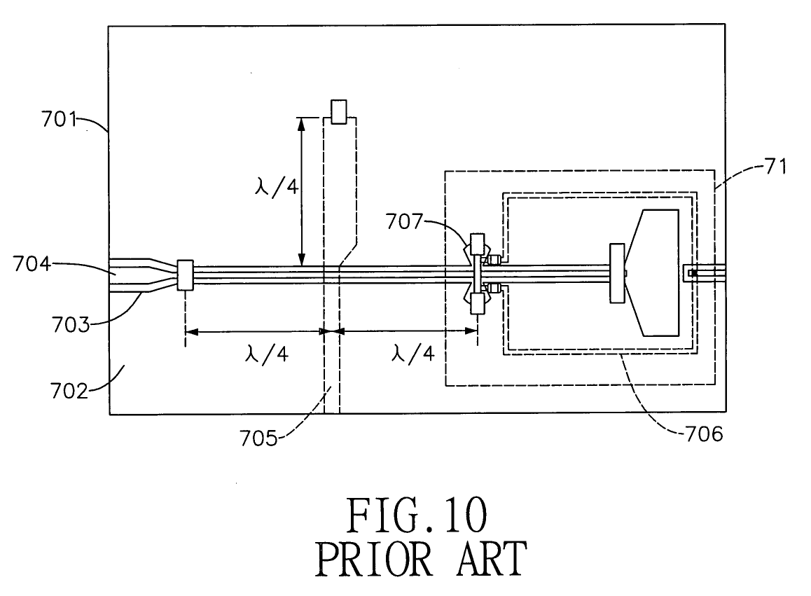

With reference to FIG. 6A, the RF signal has the amplitude of 0.2 volts and the period of 402 MHz. With reference to FIG. 6B, the local pulse signal has the period of 400 MHz. With reference to FIG. 6C the output voltages V1, V2 measured at the output ports (OUTPUT 1, OUTPUT 2) have the same amplitudes with different phases opposite to each other. With reference to FIG. 6D, the waveform of the intermediate frequency (IF) signal is similar to that on FIG. 6A but in different time scales. The time scale unit of FIG. 6A is the nanosecond and the time scale unit of FIG. 6D is microsecond (μsec). When the RF signal is sampled to generate a 2 MHz intermediate frequency signal, the amplitude of the intermediate frequency signal is approximately 0.2 volts. Further, since the intermediate frequency signal is produced based the local pulse signal and the amplitude difference between the RF signal and the intermediate signal is very small, the conversion loss of the microwave sampler is acceptable.

In conclusion, the present invention uses the electromagnetic coupling among the microstrip lines and the slot-line to form a magic T circuit, whereby the microwave sampler can be miniaturized and still has satisfied properties. The practical sample of the microwave sampler integrated with the magic T circuit and the sampling bridge circuit has a small size.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A miniaturized microwave sampler comprising:
a substrate assembly comprising a first substrate and a second substrate mounted together on a mounting surface, both the first substrate and the second substrate having a top surface and a bottom surface;
a ground layer formed on the mounting surface; and
a magic T circuit formed in the substrate assembly and comprising
a slot-line being formed on the ground layer and having a first end and a second end;
a first microstrip line being formed on the top surface of the first substrate and having a first end as local pulse signal input port, and a second end extending along a direction to perpendicularly cross to the slot-line; and
a second microstrip line being formed on the bottom surface of the second substrate, achieving an electromagnetic coupling with the first microstrip line through the slot-line, and having a longitudinal segment and a latitudinal segment both being connected together to form a T shape,
the longitudinal segment extending along a direction being parallel to the slot-line and connected to the latitudinal segment, having a first end as a radio frequency (RF) signal input port, and having a second end perpendicularly connected to the latitudinal segment.

2. The miniaturized microwave sampler as claimed in claim 1, wherein the first substrate is a rectangular substrate with two long edges and two short edges, the slot-line is formed on a center of the first substrate and longitudinally parallel to the shorter edges of the first substrate, the second end of the slot-line is enlarged to form a recess with a length approximating to λ/4.

3. The miniaturized microwave sampler as claimed in claim 2, the first-end of the slot-line is shorted to the ground plane and the second end of the slot-line having a shape selecting from a group of consisting of radial-shaped, a circular, an elliptic, a triangular or a crooked shape.

4. The miniaturized microwave sampler as claimed in claim 1, wherein the first microstrip line is longitudinal and parallel to the long edges of the first substrate, the first end of the first microstrip line is connected to a microwave connector and served as the local pulse signal input port and the second end of the first microstrip line is enlarged to form a open-circuited radial stub to which a resistor that electrically connects to the ground layer is connected, and the stub has a length approximating to λ/4.

5. The miniaturized microwave sampler as claimed in claim 2, wherein the first microstrip line is longitudinal and parallel to the long edges of the first substrate, the first end of the first microstrip line is connected to a microwave connector and served as the local pulse signal input port and the second end of the first microstrip line is enlarged to form a open-circuited radial stub to which a resistor that electrically connects to the ground layer is connected, and the stub has a length approximating to λ/4.

6. The miniaturized microwave sampler as claimed in claim 5, the stub of the first microstrip line having a shape selecting from a group of consisting of a radial-shaped, a circular, an elliptic, a triangular or a crooked shape.

7. The miniaturized microwave sampler as claimed in claim 5, wherein the first end of the longitudinal segment of the second microstrip line further extends to form an impedance converter having a length of λ/4 and being connected to a microwave connector and served as the RF signal input port.

8. The miniaturized microwave sampler as claimed in claim 7, wherein the latitudinal segment has two ends from which two wires respectively extend to the other long edge of the second substrate opposite to the impedance converter as two output ports.

9. The miniaturized microwave sampler as claimed in claim 8, wherein the two output ports are further connected to a sampling bridge circuit.
